(19) United States
(12) Patent Application Publication
(10) Pub. No.: US 2006/0125238 A1
(43) Pub. Date: Jun. 15, 2006

(54) Automatic power connector system machine

(75) Inventors: Kalishwar Das, Clarks Summit, PA (US); Santosh Kumar Sinha, Clarks Summit, PA (US)

Correspondence Address: SANTOSH KUMAR SINHA, PO BOX 554, CHINCHILA, PA, 18410, US

(73) Assignee: SANTOSH KUMAR SINHA

(21) Appl. No.: 11/263,979

(22) Filed: Nov. 2, 2005

Related U.S. Application Data
(60) Provisional application No. 60/624,574, filed on Nov. 3, 2004.

(51) Int. Cl. H02K 7/18; F03G 7/08; F02B 63/04

(52) U.S. Cl. 290/1 R

(57) ABSTRACT

The subject-matter of the present invention is a system for the generation of electrical energy by generating a high speed pulse to utilize and condense electrical energy, eliminating any possible use of external energy or a mechanical thrust, consist; a connector device being propelled using a high speed source motor (1), exhibiting at least a pair of active phases, on both side of it as a minimum demand of the system circuit, each pair working in opposite of other's function and connected by a phase connector device (3) moving with the speed of source motor (1), on each side, organized in a parallel, round or any other shape/style of Insulated Chassis. The system thus generates a benefit of (A) unique equilibrium in the source and target of the energy utilized, (B) multiple utilization of single phase at almost the same time. The rotary movement of the impeller is transmitted; from the main motor-machine where a set of mechanical gear arrangement (10) has been done on an insulated chassis (5) to benefit the source motor (1); for the generation of electrical energy. Figure-I, demonstrates the system.

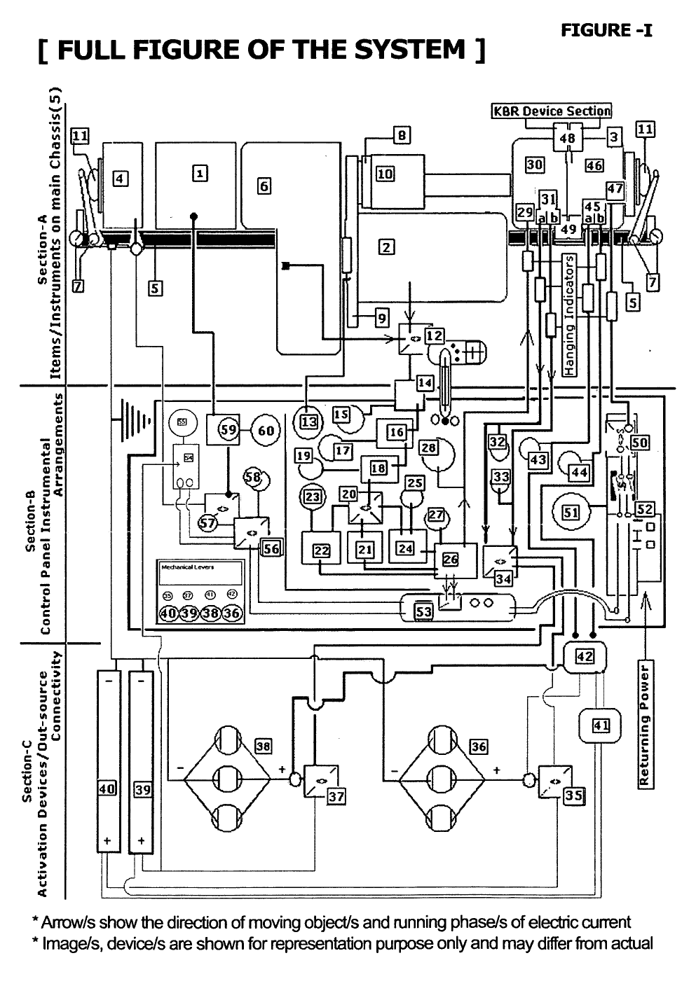

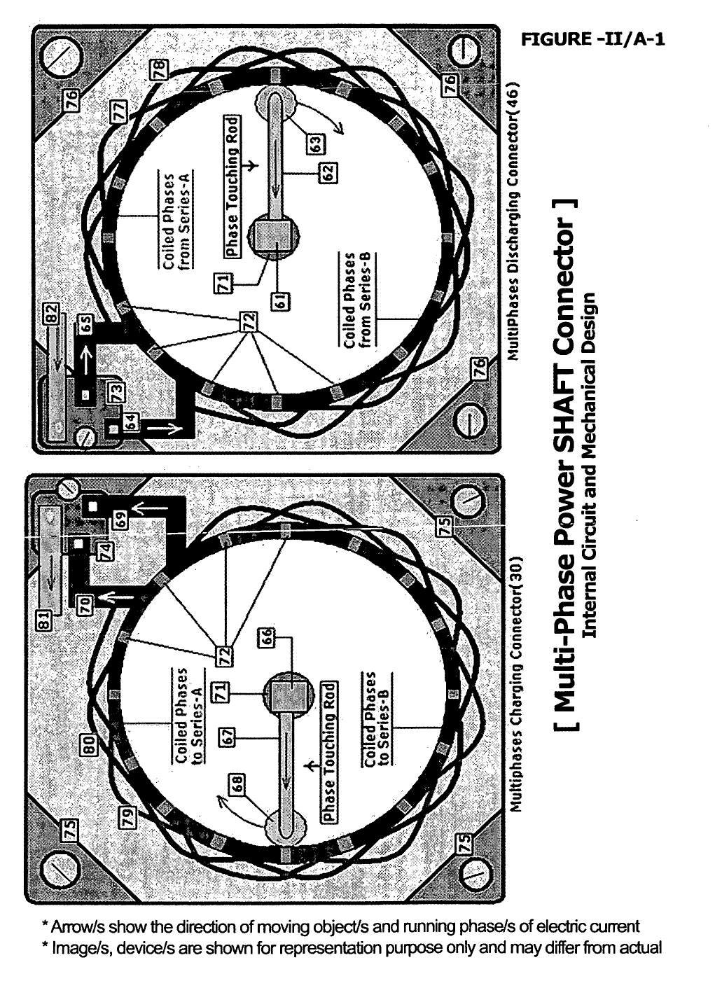

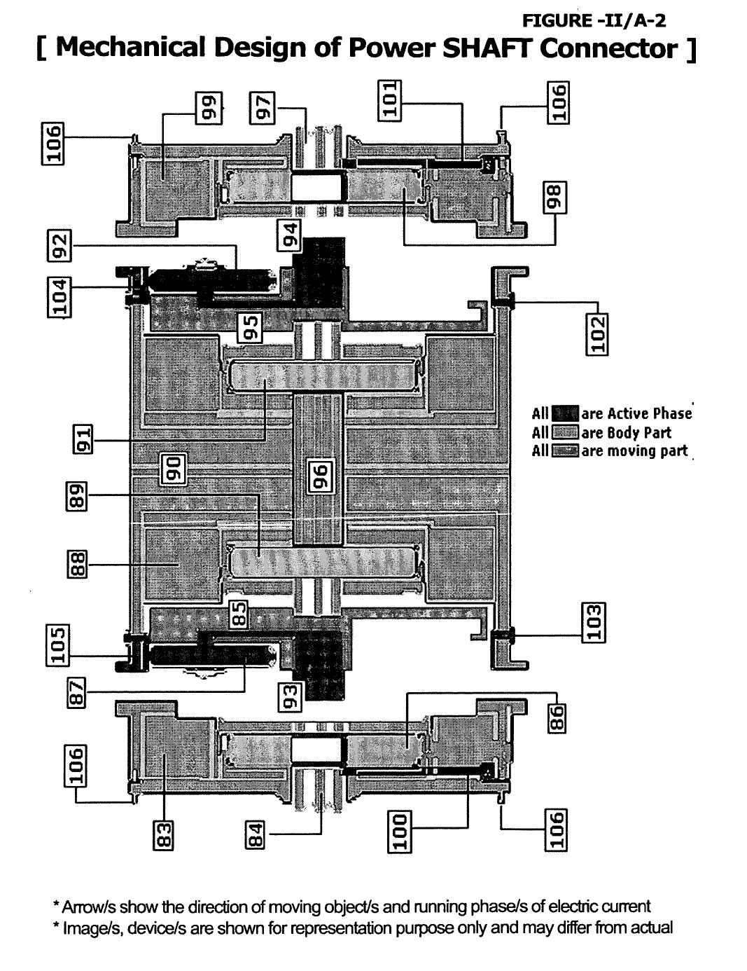

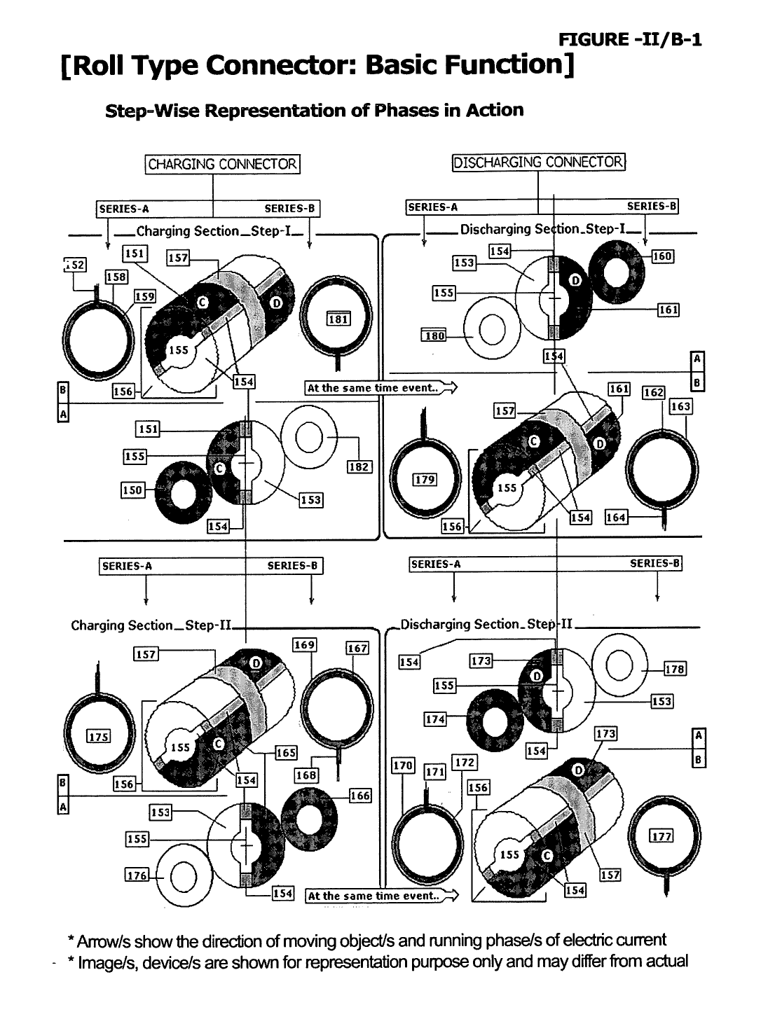

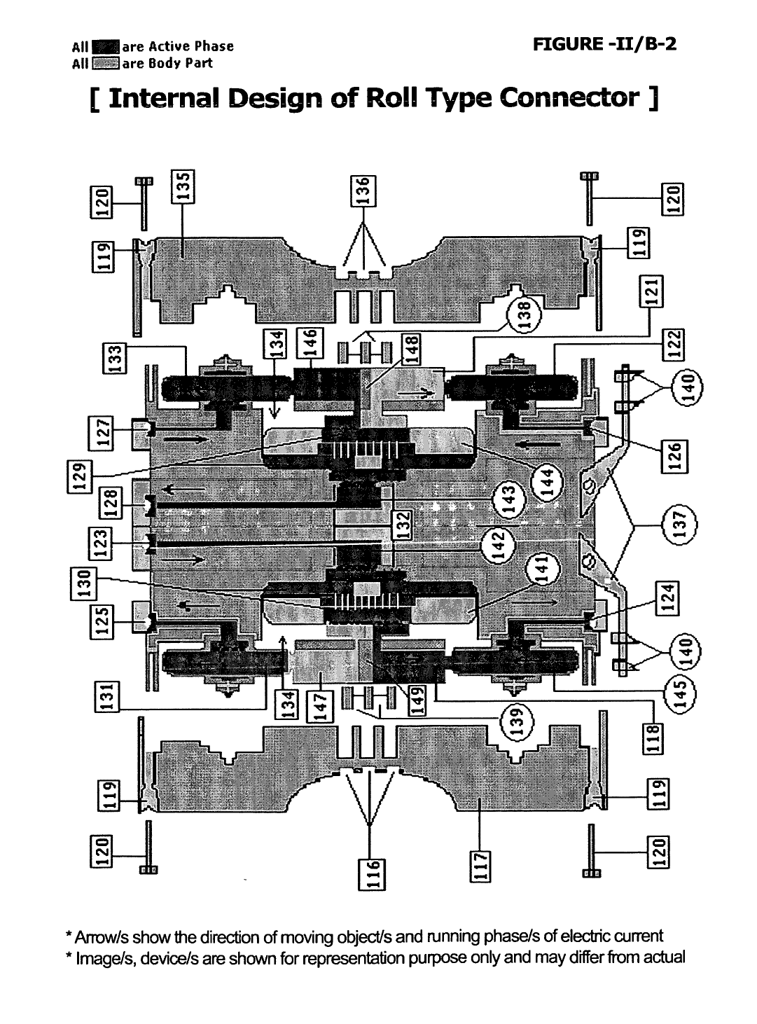

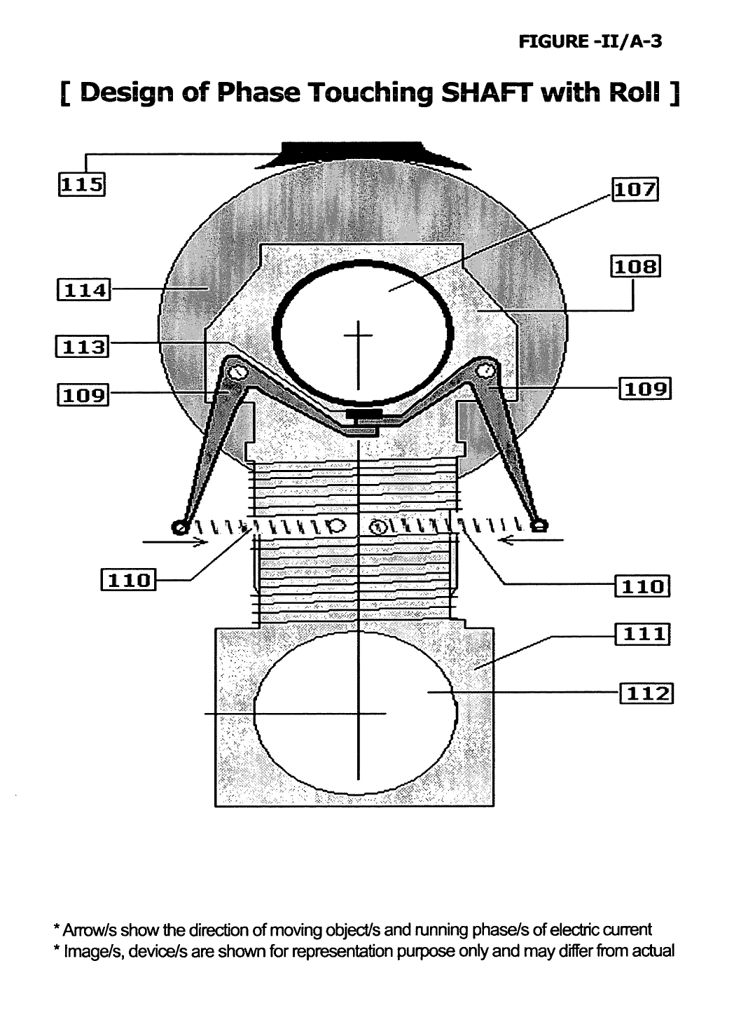

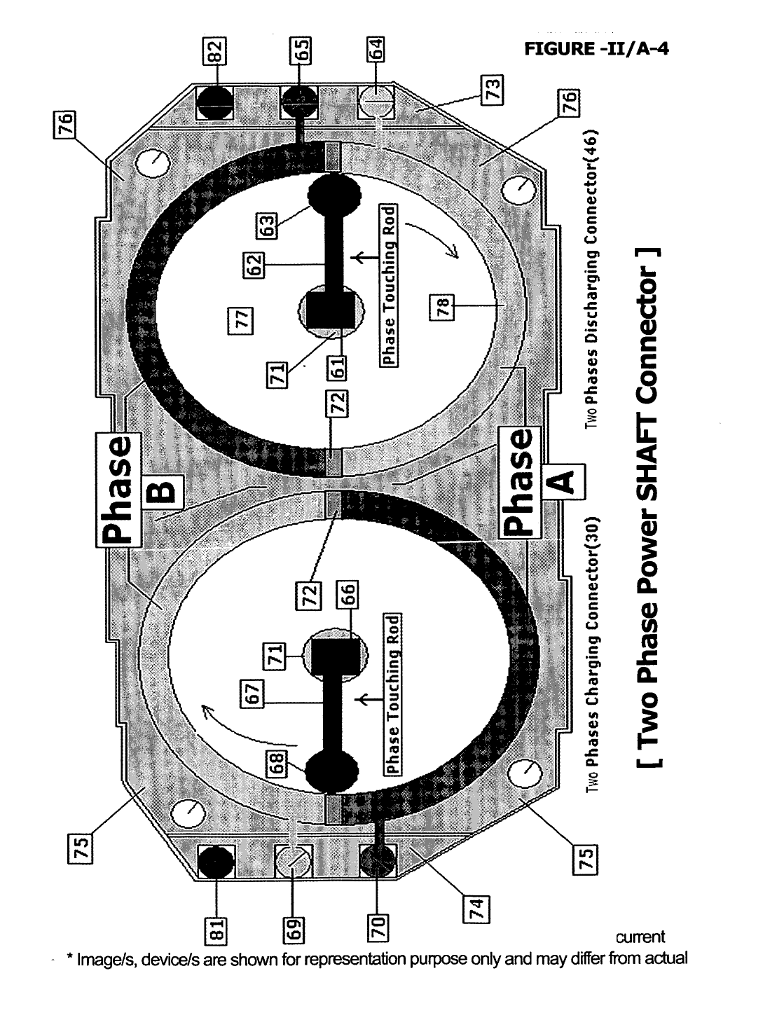

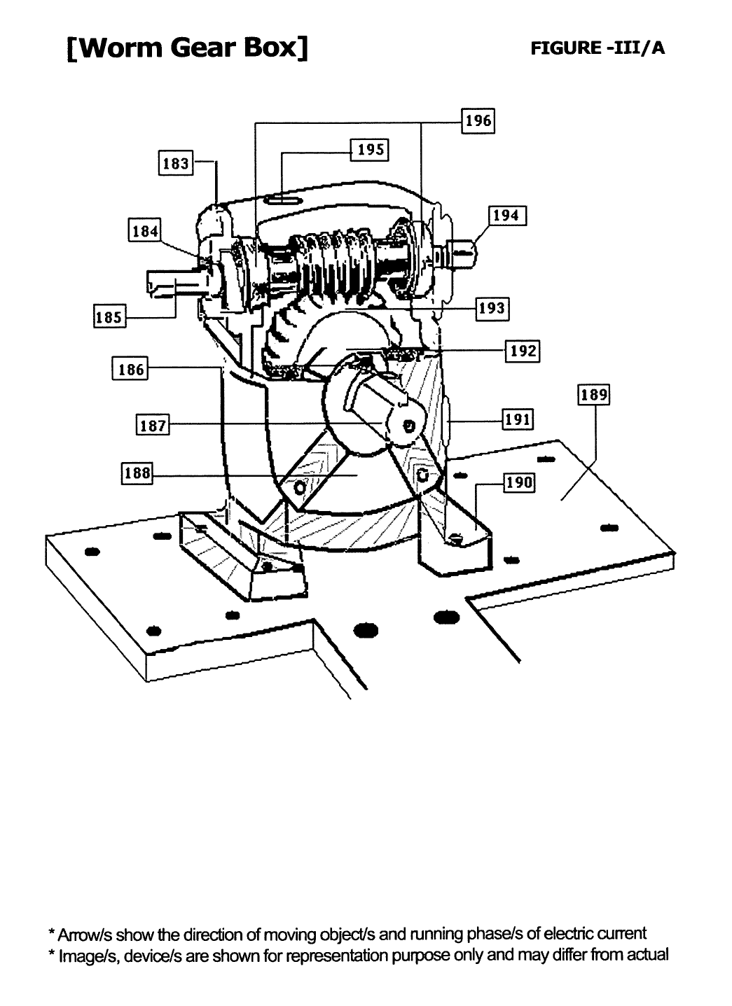

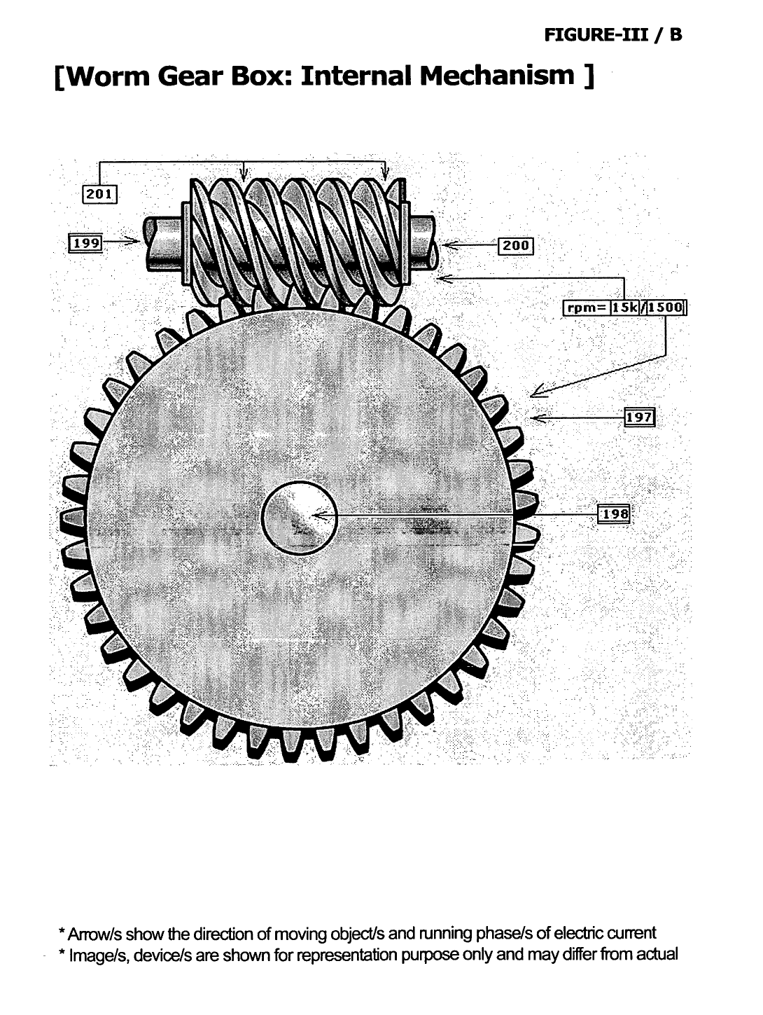

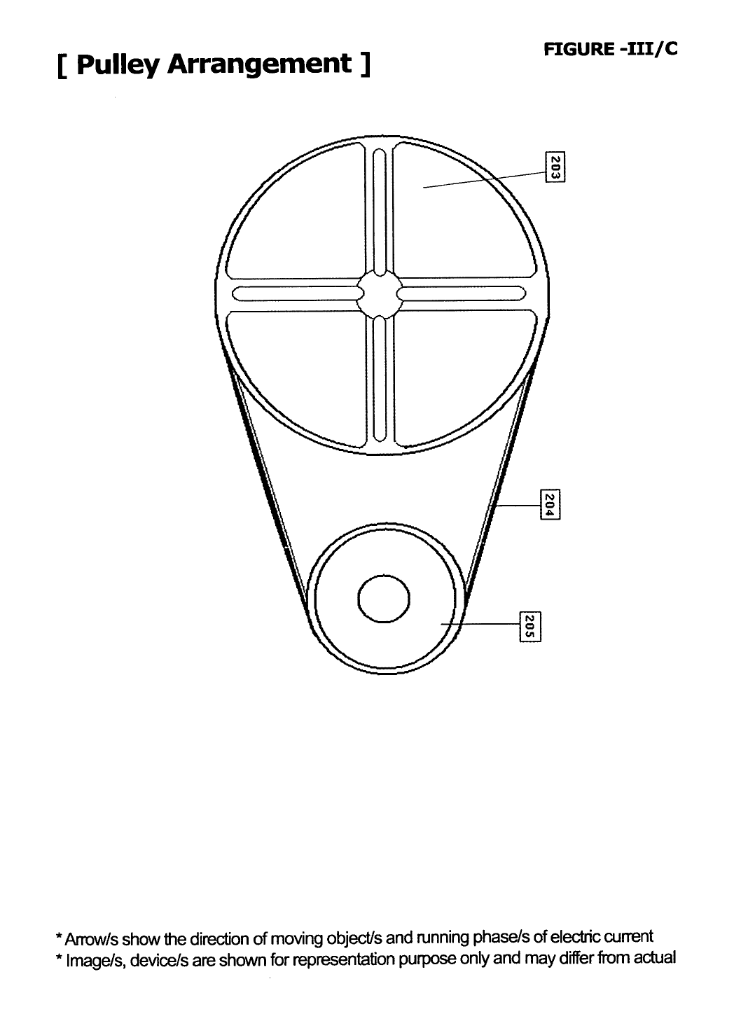

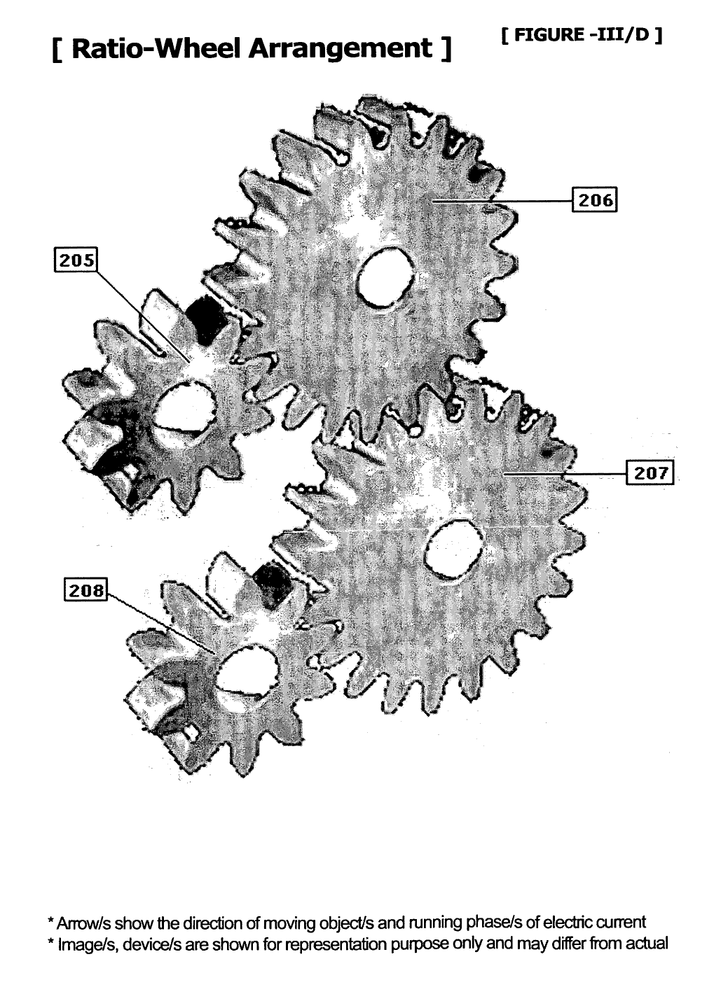

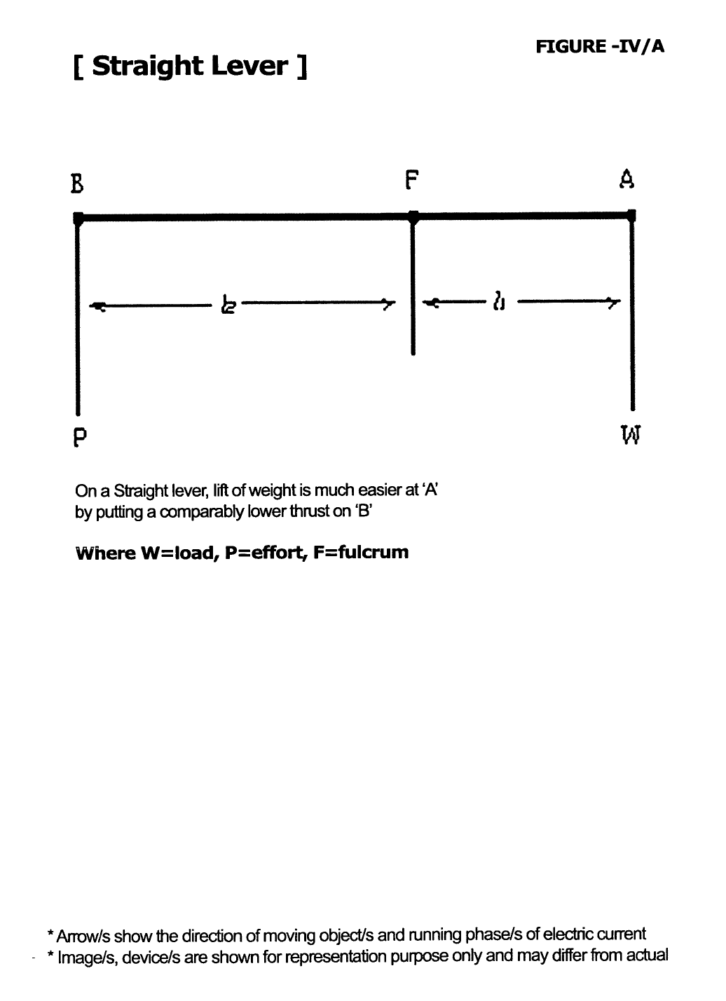

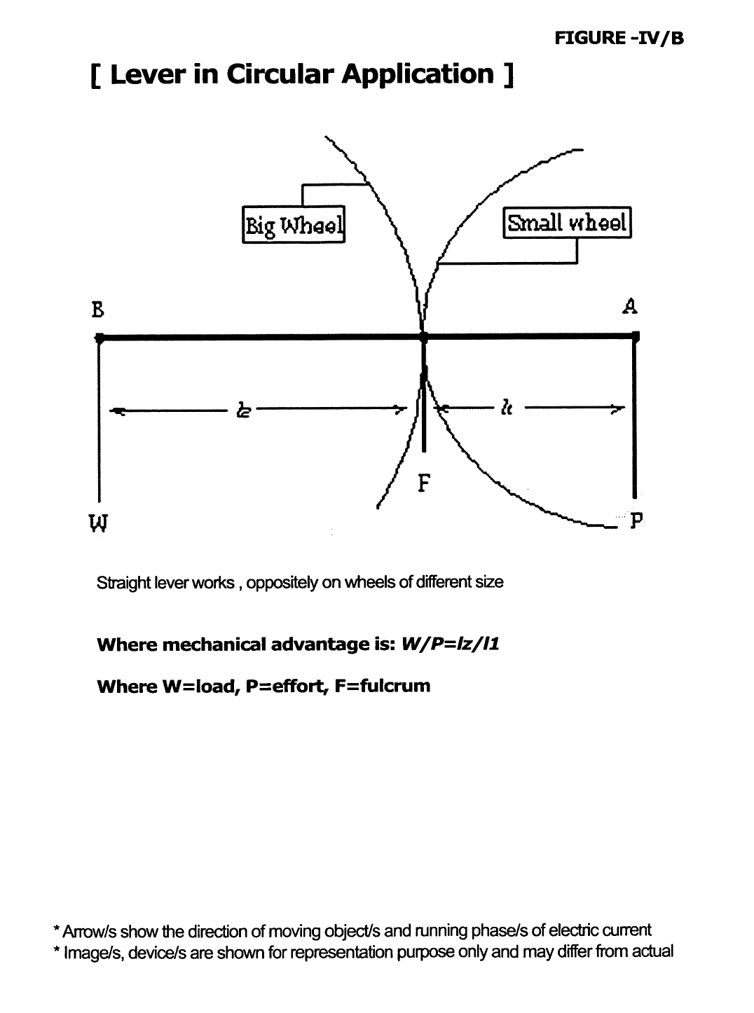

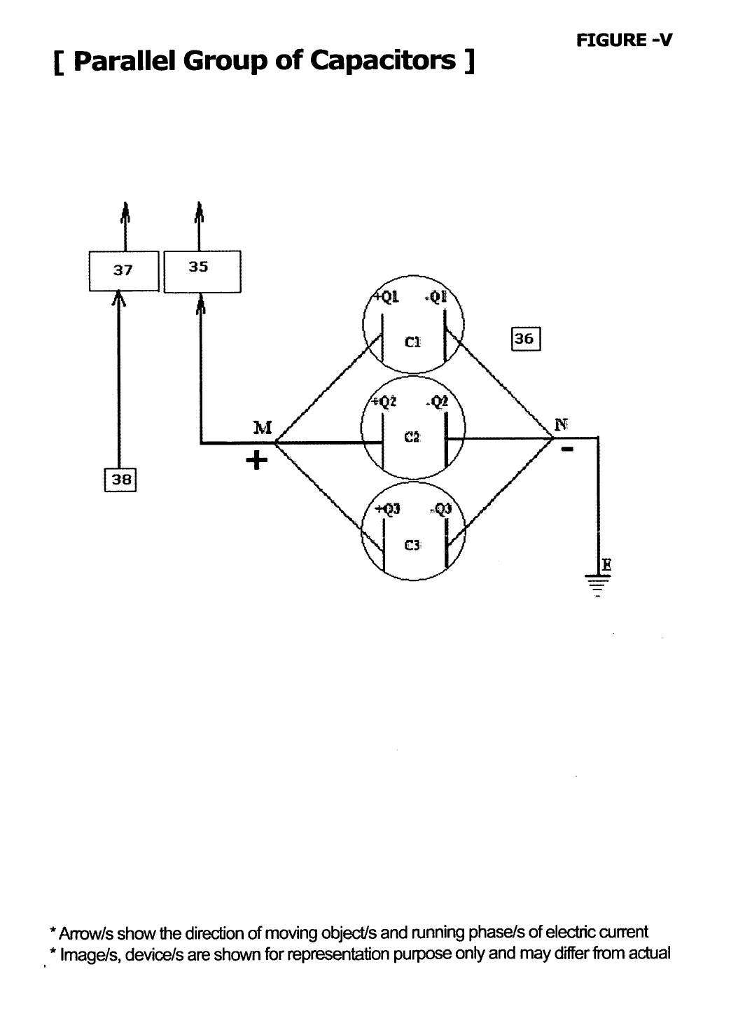

### BACKGROUND

Any source of Power Production requires an independent and a permanent base to run well but while putting the same condition with a source motor to run the source of Power generation for its own consumption it sacks with the base and independence, immediately and therefore, a fast growing rate of falling speed of the motor and due to this the required torque rate of power generation occurs and self operation stops finally.

The new automatic connector system machine over rules this negation by
(i) the generation of different timing as the freedom
(ii) the condensing of produced power by the rate of this different timing as the base and
(iii) utilizing the kinetic bonus to combat the potential resistance which is supposed to be proportional to an aggregate of resistance in any object, making the whole arrangement of devices a unique success despite the source of power generation and the consumption is maintained with an equilibrium and being run without a series collision that could cause the system to stop.

Attempt to make a machine which can run by its own produced energy is not in common practice. Established law of Physics, states that the output is always equal or proportional to the input and additionally less because of Newton's law of potential resistance (Law of Motion-I). The evolved system may feeble such theory by generating ‘intangible pulse’ in power utilization and gaining the kinetic/quantum bonus of mechanical advantage in electrical terms. This Patent Specification represents the device to generate ‘intangible pulse’—the Automatic Power Connector System Machine.

Work subtracted by the applied resistance and multiplied with the time taken, is equal to work done, never ends, as if, the work done is kept secured to be used with a shortest gap of period, combating an approximate zero, known as an ‘intangible pulse’, achievement of which is the background and a novelty of this invention. According to the first rule of Newton, static forces as a natural force, is active in every object until the force active to make it to move does not loses before the Newton's natural force carried out by the resistance. Only due to this rule, Prime Motor (1) can not run at its own produced power as if, used directly because the motion of the Prime Motor (1) falls fast by the rate of a cumulative series and mechanical resistance, before the baseless produced power soon after it is connected directly and it stops running, ultimately. Any source of Power Production thus requires an independent and a permanent base to run smoothly, but while putting the same condition with a source motor to run the source of Power generation for its own consumption, it sacks its own base and independence due to natural circuit and mechanical resistance and therefore a fast growing rate of falling speed of the motor and due to this the required torque rate of power generation falls rapidly and self operation stops finally.

The new automatic power connector system machine over rules this negation by (i) the generation of an ‘intangible mechanical pulse’ (ii) completely averting the circuit from any possible Collision (iii) receiving of Kinetic Bonus (iv) condensing the power and (v) releasing the power quickly (vi) generated at the rate of an ‘intangible pulse’ (vii) by a new mechanical arrangement as the base of the system; making the whole arrangement of devices a success despite the source of power generation and the consumption is kept always active at the pair of ports running in parallel and without the Collision of running series. All it happens without the continuous use of any external energy as the primary base.

### MORE CLARIFICATION

### Problem Statement

An electric Motor can operate a Power Generator, which produces energy, but by the use of this produced energy, same Motor can not be operated regularly and an extra output can not be gained because the grip of natural resistance works to bring down:
1. the speed of Motor at first and therefore
2. in the rate of production of energy simultaneously and
3. this arrangement of self operation falls ultimately to an absolute rest.

### The Solution

Present Invention of cyclic system of power transmission ‘The Automatic Power Connector System Machine’ solves this problem and is named therefore, an ‘Automatic’ for the ‘Power Connector System Machine’ the primary subject matter of the Patent. The prime target of this new system is to ensure the Collision-free power transmission in the pair/s of circuits that run in parallel but works in opposition i.e. one works for charging the series while other works for discharging the series at the same time. To do this without facing any Collision, a pair of series has been arranged and each series comprises of device/s that best suits to the total or a minimum need of the circuit/system. It is therefore, the system uses the single phases in double operation at almost the same time, the circuit maintenance/requirement of which is though not required to set in double. Thus this is the system of a cyclic arrangement of Collision free power transmission through a new device “Automatic Power Connector System Machine” and several other electric and electronic devices making the whole system a phenomenal success.

The Automatic Power Connector (3) System Machine produces an ‘intangible pulse’ of power transmission in the main circuit of production and consumption, enabling the whole system to run automatic and self-propelled which is the novelty of this system along the capacity to render an extra power as an output.

Not intangible at first, the pulse rate in the use of produced and accumulated energy was felt necessary but while on trial it happened to be the prime necessity to achieve the target for operating Motor (1) with its own source of energy and it happened possible with the use of Power Connector Machine (3)

### BRIEF SUMMARY

A Unique equilibrium between ‘temporary accumulation’ and ‘quick release’ is achieved by the new system by using a pair of different power mode connectors along with the Lever's theory of angular force that benefits to the circuit in the terms of a mechanical advantage (ma=torque), measured, by distance from the center of an arc, the exact distance of which, depends upon the speed of motor and the net requirement of speed by the Power Generator and is counted in the unit of its radius. The Invented technique of this system is the technique of making Power supply in a pair of ways to conduct such a phenomena to generate equilibrium in the production and consumption line and thus to gain extra output at the same time from the same device put in active use.

This is a cyclic system of transmitting self-produced electric energy to obtain equilibrium in its circuit, achieved by the use of a Multi-Phase Power Connector Machine (3) in double frame as shown in Figure-I along with a High Speed Motor (1), Double series of repositories i.e. the Capacitors (36 & 38)/rechargeable batteries (39 & 40) and a Power Generator (2) with an optional Power Generator (6), all fixed on an insulated chassis (5) with a Speed Reducer Device (10) which works to accommodate the need of the speed varying from device to device at the same time of operation.

Life of this Cyclic system of bringing power equilibrium exists until a required amount of energy is regularly supplied from the repository unit, and as the main feature of this system machine is its “infinite” running life, machine almost never stops running but may drop into (1) a standby condition or may stop running therefore failing to supply power to the external energy unit if repository device turn weaken or die or the internal circuit or any extra mechanical resistance causes system to down its speed.

Machine does not require to store Power in a set of Capacitors that is necessarily charged in prior rather it requires a set of charged batteries of at least minimum of its charge to render a full of necessary thrust on the miniature of the Power generator (2) through starting motor (4), at least for a first few seconds. However if, the batteries are not adequately charged, machine may take extra time to get started and be able to run on its own.

Once the batteries get charged fully or even partially, system becomes ready to activate its repositories circuit to run on its own source for an “infinite” period, without any external source of energy.

In the main structure as shown in Figure-I, Section-A, on an Insulated chassis (5), both Charging/‘temporary accumulating’ (30) and Discharging/‘quick release’ (46) Connectors (3) are attached with the Power Generator (2 and 6) and High Speed Source Motor (1), through a Worm Gear Box (10) to follow the rule of lever here and due to this mechanical arrangement Power generation begins soon after the required energy is supplied into the High Speed Motor (1) whether:

A. For the generation of an adequate amount of energy, Power Generator (2) needs a certain limit of revolution and an adequate mechanical thrust (force=f) at its miniature which is fulfilled with the use of:

B. A High Speed Direct Current Motor (1) rendering the speed at the rate of at least ten times greater than the need of the Power generator (2) by gaining the mechanical advantage through speed reducer (10) device and therefore, consuming a lesser amount of energy by adapting:

C. the Lever's theory of angular force measured in the terms of distance from the center of an arc by applying this on the system of wheels to gain the same mechanical advantage in opposite direction and by the use of some conventional speed reducing devices and the new:

D. Combined Automatic Power Connector System Machine (3) in double (30 and 46) to bring equilibrium in power production and consumption therefore:

E. As soon as the series of repositories i.e. Active Capacitors (36) and (38)/Charged or getting charged, batteries (39) and (40) is gauged in position to run Prime Motor (1), starter switch (57), is left off and thus the High Speed Motor starts running with its own source of power, released from the double series of repositories arranged in parallel following the fact that

F. the series of repositories i.e. Capacitors/batteries get activated/accumulated in an opposite order of its discharging and

G. it happens possible by the use of Automatic Power Connector System Machine (3), which ascertains:

H. a Collision-free ‘temporary accumulation’ and ‘quick release’ of accumulated power to the Source Motor (1) at the same time and “without a tangible gap of its working period” to benefit the whole system a kinetic bonus in the later step, whether:
I. Kinetic Bonus is the part of this system device but mechanism of this peculiar device is the subject of another patent application.
J. By the virtue of this device and at the cost of single charge, charging of double series of Capacitors/batteries is done successfully without any risk or loss in the form of circuit Collision.

### NAMES OF THE DEVICES: TITLE DESCRIPTIONS

ON A SINGLE SHEET

Figure-I: Full Figure of the System has THREE sections:

| | |
|---|---|
| Section-A: Items/Instruments on main Chassis(5) | marked as FIGURE-I |
| Section-B: Control Panel Instrumental Arrangements | marked as FIGURE-I |
| Section-C: Activation devices/Out-source connectivity | marked as FIGURE-I |

Figure-II: Connector of possible types and design has TWO sections:

| | |
|---|---|
| Section-A: Shaft Type Connector has FOUR subsections: | |
| Subsection-I: Multi-Phase Power SHAFT Connector | marked as FIGURE-II/A-1 |
| Subsection-II: Mech. Design of Power SHAFT Connector | marked as FIGURE-II/A-2 |
| Subsection-III: Design of Phase Touching SHAFT with ROLL | marked as FIGURE-II/A-3 |
| Subsection-IV: Two Phase Power SHAFT Connector | marked as FIGURE-II/A-4 |
| Section-B: Roll Type Connector has TWO subsections: | |
| Subsection-I: Roll Type Connector: Basic Function | marked as FIGURE-II/B-1 |
| Subsection-II: Internal Design of Roll Type Connector | marked as FIGURE-II/B-2 |

Figure-III: Speed Reducing Arrangements has FOUR Sections:

| | |
|---|---|
| Section-A: Worm Gear Box | marked as FIGURE-III/A |
| Section-B: Worm Gear Box: Internal Mechanism | marked as FIGURE-III/B |
| Section-C: Pulley Arrangement | marked as FIGURE-III/C |
| Section-D: Ratio-wheel Arrangement | marked as FIGURE-III/D |

Figure-IV: Representation of Lever has TWO Sections:

| | |
|---|---|
| Section-A: Straight lever | marked as FIGURE-IV-A |
| Section-B: Lever in Circular Application | marked as FIGURE-IV-B |

Figure-V: Parallel Group of Capacitors

| | |
|---|---|
| | marked as FIGURE-V |
| Total Number of Figures: | 14 (FORTEEN) |

Figure-I: Full Figure of the System

Section-A: Items/Instruments on main Chassis (5) marked as FIGURE-I

| Item code N^{o}. | Names of the Items |
|---|---|
| (1) | High Speed Source DC Motor |
| (2) | AC Power Generator |
| (3) | Combined Power Connectors |
| (4) | DC Starter Motor |
| (5) | Main Insulated Chassis |
| (6) | Optional AC Power Generator |
| (7) | Chassis Tightener |
| (8) | Small wheel of Source Motor (1) |
| (9) | Big wheel of AC Power Generator (2) |
| (10) | Worm Gear Box |
| (11) | Instrument Tightener |
| (12) | Gen Set Selecting Lever |
| (29) | Incoming Receiving port of Charging |
| (30) | Accumulating/Charging Connector |
| (31-a) | Outgoing Accumulating/Charging Phase to first series |
| (31-b) | Outgoing Accumulating/Charging Phase to second series |
| (45-a) | Incoming quick release/Discharging Phase from |
| | first series |
| (45-b) | Incoming quick release/Discharging Phase from second |
| | series |
| (46) | Quick release/Discharging Connector |
| (47) | Outgoing port of quick release/Discharging Connector |
| (48) | Kinetic Bonus Receiver Device-A (hidden in this patent |
| | specification) |
| (49) | Kinetic Bonus Receiver Device-B (hidden in this patent |
| | specification) |

Figure-I: Full Figure of the System

Section-B: Control Panel Instrumental Arrangements: marked as FIGURE-I

| Item code N^{o}. | Names of the Items |
|---|---|
| (13) | Speedometer (RPM) |
| (14) | First Incoming Phase Controller |
| (15) | Power Production Meter |
| (16) | AC Transformer |
| (17) | Volt Meter |
| (18) | Rectifier |
| (19) | DC Watt Meter |
| (20) | Final Charge Selector Switch |
| (21) | Normal charge |
| (22) | Resistor |
| (23) | Ohm Meter |
| (24) | Booster Instrument |
| (25) | Booster relay Monitor |
| (26) | Input/Output relay Junction |
| (27) | Control Monitor |
| (28) | Single Phase Charge relay Meter |
| (32) | Incoming Charging for first series of condenser/ |
| | rechargeable battery |
| (33) | Incoming Charging for second series of condenser/ |
| | rechargeable battery |
| (34) | Incoming Charge distributor/selector PORT-I |
| (43) | Incoming Discharge relay Monitor of first series |
| (44) | Incoming Discharge relay Monitor of second series |
| (50) | Out-coming Discharge relay - SECONDARY OUTPUT |
| | SECTION |
| (51) | Out-coming discharge relay Monitor |
| (52) | OUTPUT SECTION |
| (53) | PRIMARY OUTPUT SECTION |
| (54) | DC Transformer for Starter Motor(4) |
| (55) | DC Transformer(54) and Starter Motor(4) Monitor |
| (56) | System Starter Switch |
| (57) | First thrust switch |
| (58) | Final Monitor of System Potential |
| (59) | Control Panel Connecting Juncture |
| (60) | Comparing Monitor |

Figure-I: Full Figure of the System

Section-C: Activation Devices/Out-source Connectivity marked as FIGURE-I

| Item code N^{o}. | Names of the Items |
|---|---|
| (35) | Charge distributor/selector PORT-II |
| (36) | Quick Release Capacitor: Series-A |
| (37) | Charge distributor/selector PORT-III |
| (38) | Quick Release Capacitor: Series-B |
| (39) | Rechargeable batteries Series-A |
| (40) | Rechargeable batteries Series-B |
| (41) | Startup Switch |
| (42) | Main Runner Switch |

Figure-II_Connector

Section-A: Multi-Phase Power SHAFT Connector:

Subsection-I: Internal Circuit and Mechanical Design marked as FIGURE-II/A-1

| Item code N^{o}. | Names of the Items |
|---|---|
| (61) | Rectangular hole for passing central roll |
| (62) | Discharging shaft |
| (63) | Active Roll Pad for Discharging |
| (64) | Incoming Discharging Phase from Second series of |
| | Condenser/batteries |
| (65) | Incoming Discharging Phase from First series of |
| | Condenser/batteries |
| (66) | Rectangular hole for passing central roll |
| (67) | Charging shaft |
| (68) | Active Roll Pad for Charging |
| (69) | Outgoing Charging Phase to Second series |
| (70) | Outgoing Charging Phase to First series |
| (71) | Crossing Hole of the Combined Connectors |
| (72) | Neutral Phases |
| (73) | Insulated Box of Discharging Connections |
| (74) | Insulated Box of Charging Connections |
| (75) | Charging Connector's Body/Fixed with Volts |
| (76) | Discharging Connector's Body/Fixed with Volts |
| (77) | Phase Coiling of First series on Discharging Connector |
| (78) | Phase Coiling of Second series on Discharging Connector |
| (79) | Phase Coiling of First series on Charging Connector |
| (80) | Phase Coiling of Second series on Charging Connector |
| (81) | Incoming Power Connection for Charging |
| (82) | Outgoing Power Connection for Discharging |

Figure-II_Connector

Section-A: Multi-Phase Power SHAFT Connector:

Subsection-II: Internal Design and Instrumental Arrangement marked as FIGURE-II/A-2

| Item code N^{o}. | Names of the Items |
|---|---|
| (83) | Connector's Cover: Charging Side |
| (84) | Cross Roll Pass-Charging side |
| (85) | Moving SHAFT: Charging Side |
| (86) | Cover Bearing |
| (87) | Active Bearing of Charging Side |
| (88) | Bearing Protecting Cover |
| (89) | Prime Load Bearing-I |
| (90) | Main Body of the Shaft Connector |
| (91) | Prime Load Bearing-II |
| (92) | Active Bearing of Discharging side |
| (93) | Active Current Transmission for Charging |
| (94) | Active Current Transmission for Discharging |
| (95) | Moving SHAFT Discharging side |
| (96) | Central Cross Roll |
| (97) | Cross Roll Pass-Discharging side |
| (98) | Cover Bearing |
| (99) | Connector's Cover: Discharging Side |
| (100) | Incoming Current Pass |
| (101) | Outgoing Current Pass |
| (102) | Incoming Current Pass Phase-A |
| (103) | Outgoing Current Pass Phase-B |
| (104) | Incoming Current Pass Phase-B |
| (105) | Outgoing Current Pass Phase-A |
| (106) | Cover Fixer Bolts |

Figure-II_Connector

Section-A: Multi-Phase Power SHAFT Connector:

Subsection-III: Design of Phase Touching SHAFT with Roll marked as FIGURE-II/A-3

| Item code N^{o}. | Names of the Items |
|---|---|
| (107) | Prime Bolt on Touching Shaft with Roll |
| (108) | Phase Conductor Upper Shaft |
| (109) | Lever to lift Prime Bolt section toward Active Phase |
| | (115) |
| (110) | Lever Fastening Spring |
| (111) | Phase Conductor Lower Shaft |
| (112) | Rectangular Hole to hold thrust |
| (113) | Prime Bolt Holder Pulley |
| (114) | ACTIVE ROLL |
| (115) | ACTIVE PHASE (shown roughly) |

Figure-II_Connector

Section-A: Two Phase Power SHAFT Connector:

Subsection-IV: Internal Circuit and Mechanical Design marked as FIGURE-II/A-4

For this section: Names of the devices shown are numbered equally as shown and numbered in subsection-I and there are no extra devices shown therein except the differences of their make i.e. the number of phases as shown therein.

Figure-II: Connector

Section-B: Roll Type Connector ON A SINGLE SHEET

Subsection-I: Internal Design of Roll Type Connector marked as FIGURE-II/B-2

| Item code N^{o}. | Names of the Items |
|---|---|
| (116) | Cross Roll Pass: Charging Side |
| (117) | Cover of the Connector: Charging side |
| (118) | ACTIVE CHARGING ROLL-PAD |
| (119) | Nut/s to tighten the Cover/s |
| (120) | Bolt/s to hold Nut/s (119) |
| (121) | INACTIVE ROLL-PAD |
| (122) | Discharging Phase Bearing-A |
| (123) | Incoming Charging Phase |
| (124) | Outgoing Charging Phase |
| (125) | Outgoing Charging Phase |
| (126) | Incoming Discharged Phase |
| (127) | Incoming Discharged Phase |
| (128) | Outgoing Discharged Phase |
| (129) | ACTIVE ROLL PASS |
| (130) | ACTIVE ROLL PASS |
| (131) | Charging Phase Bearing series-A |
| (132) | Cross Roll |
| (133) | Discharging Phase Bearing series-B |
| (134) | Internal Bearing Holder |
| (135) | Cover of the Connector: Discharging side |
| (136) | Cross Roll Pass: Discharging side |
| (137) | Roll Type Connector's Stand |
| (138) | Discharging side Roll-end |
| (139) | Charging side Roll-end |
| (140) | Bolt/s to hold Stand (137) |
| (141) | Insulation Coating on Internal Bearing-side-A |
| (142) | Active Phase Pass-Charging side |
| (143) | Active Phase Pass-Discharging side |
| (144) | Insulation Coating on Internal Bearing-side-B |
| (145) | Charging Phase Bearing series-B |
| (146) | ACTIVE DISCHARGING ROLL-PAD |
| (147) | INACTIVE ROLL-PAD |
| (148) | MEDIAN NUTRAL PHASE: DISCHARGING SIDE |
| (149) | MEDIAN NUTRAL PHASE: CHARGING SIDE |

Figure-II: Connector

Section-B: Roll Type Connector ON A SINGLE SHEET

Subsection-II: Basic Function marked as FIGURE-II/B-1

Basic Function of Roll type Charging and Discharging Connector has been shown in four steps and have further been divided into two subsequent parts.

| | |
|---|---|
| Item code N^{o}. | Names of the Items |

COMMON SECTION

| | |
|---|---|
| (153) | Inactive Roll-Pad |
| (154) | Median Neutral Phase |
| (155) | Hole for Cross Roll Pass |
| (156) | Complete Roll with Active Pads on it |
| (157) | Neutral Divider between Charging and Discharging |
| | section |

Charging Section: Step-I

| | |
|---|---|
| (150) | Active Charging Bearing-Roll of Series-A |
| (151) | Main Active Charging Roll-Pad of Series-A |
| (152) | Binding Pass to Series-A |
| (158) | Insulating Coating on Active Binding |
| (159) | Binding for Charging to Series-A |
| (181) | Binding-Set for Charging to Series-B |
| (182) | Bearing-Roll of Series-B |

Discharging Section: Step-I

| | |
|---|---|
| (160) | Active Discharging Bearing-Roll of Series-B |
| (161) | Main Active Discharging Roll-Pad of Series-B |
| (162) | Binding Pass to Series-B |
| (163) | Insulating Coating on Active Binding |
| (164) | Binding for Discharging to Series-B |
| (179) | Binding-Set for Discharging to Series-A |
| (180) | Bearing-Roll of Series-A |

Charging Section: Step-II

| | |
|---|---|
| (165) | Main Active Charging Roll-Pad of Series-B |
| (166) | Active Charging Bearing-Roll of Series-B |
| (167) | Binding for Charging to Series-B |
| (168) | Binding Pass to Series-B |
| (169) | Insulating Coating on Active Binding |
| (175) | Binding-Set for Charging to Series-A |
| (176) | Bearing-Roll of Series-A |

Discharging Section: Step-II

| | |
|---|---|
| (170) | Insulating Coating on Active Binding |
| (171) | Binding Pass to Series-A |
| (172) | Binding for Discharging to Series-A |
| (173) | Main Active Discharging Roll-Pad of Series-A |
| (174) | Active Discharging Bearing-Roll of Series-A |
| (177) | Binding-Set for Discharging to Series-B |
| (178) | Bearing-Roll of Series-B |

Figure-III: Speed Reducing Arrangements:

| Item code N^{o}. | Names of the Items | |
|---|---|---|
| Section-A: | Worm Gear Box Full Format | marked as FIGURE-III/A |
| (183) | Input Shaft Cover | |
| (184) | Oil Seal | |
| (185) | Worm Shaft from Motor | |
| (186) | Oil Seal | |
| (187) | Output Shaft to Generator | |
| (188) | Output Cover | |
| (189) | ‘T’ type system motherboard | |
| (190) | Frame of Worm Gear Box | |
| (191) | Oil Gauge | |
| (192) | Bearing | |
| (193) | Worm Wheel | |
| (194) | Worm Shaft to Connector | |
| (195) | Oil Hole Cover | |
| (196) | Bearings | |
| Section-B: | Worm Gear Box: Internal | marked as FIGURE-III/B |
| | Mechanism | |
| (197) | Worm Gear Teeth | |
| (198) | Generator's Shaft | |
| (199) | Worm Shaft toward Source | |
| | Motor | |
| (200) | Worm Shaft toward Power | |
| | Connector | |
| (201) | Teeth of the Worm Shaft | |
| Section-C: | Pulley Arrangement | marked as FIGURE-III/C |
| (202) | Small Wheel of Source Motor | |
| (203) | Big Wheel of Power | |
| | Generator | |
| (204) | Rubber Belt | |
| Section-D: | Ratio-Wheel Arrangement | marked as FIGURE-III/D |
| (205) | Source Wheel | |
| (206) | Transmission Wheel | |
| (207) | Generator's Wheel | |
| (208) | Connector's Wheel | |

Representation of Figure-IV-A (Straight Lever) and Figure-IV-B (Lever Circular Application) have no description of devices rather they are well narrated in the description part.

Figure-V: Parallel Group of Capacitors:

Numbers of the devices on this Figure with their description have been repeated which can be read similarly at Figure-I, Section-C of Activation devices/Out-source Connectivity as:

| Item code N^{o}. | Names of the Items |
|---|---|
| (35) | Charge distributor/selector PORT-II |
| (36) | Quick Release Capacitor: Series-A |
| (37) | Charge distributor/selector PORT-III |
| (38) | Quick Release Capacitor: Series-B |

### DETAIL OF THE SYSTEM

This technique of cyclic system of power transmission for the self propulsion of Motor can be shaped in any size and of any capacity, the maximum or the minimum limit of which depends upon the capacity of Motor and Power generator itself along the capacity of Capacitors in the term of its viable period despite the condensing of produced power is done in double and for a period counted in term less than a second but are used for a single operation of running Motor. Regardless of number of charging phase/s; dual condensing for each ‘single charging phase’ has significant advantage as kinetic bonus because of gaining ‘intangible pulse’ in charging through ‘charging Power Connector’ has proven an extra efficiency to fulfill the need of whole circuit and by the use of Liver's theory of wheel arrangement as shown in Figure-IV/B, where mechanical advantage is measured in somewhat circular term i.e. ma=l¹/l² instead of l²/l¹ where l¹ is a loading lever and l² is a effort lever. In the terms of circular motion both levers are converted to the radius of the moving wheel with the complete transformation of mechanical force to each other. Though the size of these radius are different therefore the size of (wheel) is different and it is, therefore, the arrangement of wheel/s to reduce the speed of the bigger wheel to gain mechanical advantage of torque, is done accordingly as shown in the Figure-III/A and Figure-III/B whether, Figure-Figure-III/C and Figure-III/D are the figures of the optional mechanical arrangements that can also be applied in any case of change of situation.

All these arrangements make at high speed of motor divided by the needed lower speed of power generator and by using the second ‘quick release’ unit-II, doing its work in an opposite time of ‘quick release’ unit-I, Connector making the whole system working in complete automation. System requires an equal rate of power release counted in the terms of an ‘Intangible Pulse’ and which is not necessarily less than the term or unit, a NANO refers to. None of existing rechargeable battery can satisfy this need of the system, even if an instant release of power on equal rate of its accumulation. Despite this fact, the rechargeable batteries (39) and (40) in two equal series has been kept with the system for an optional use beside they are utilized to activate the capacitors and its circuits. A pair of selector switches (35) and (37) based on the Control Panel shown in Section-C of Activation Part in Figure-I, have been used to select which of the such device for any of the series and for the activation of the System will be used and which will be kept in suspension.

The act to keep the rate of ‘temporary accumulation’ and ‘quick release’ constant or equal, is the prime objective of this system which is achieved only due to the use of Automatic Power Connector System Machine (3) which keeps the power circuit of both the part—‘temporary accumulation’ and ‘quick release’, free from internal circuit resistance, safe and rendering a constant work mode, at the same time. As Connector Machine leaves no chance to handle its internal operation manually, Power Connector System Machine has been called ‘Automatic’

Automatic Power Connector System Machine even while operating both series of capacitors, never falls in power resisting condition despite the rate of ‘temporary accumulation’ sometime starts generating a higher demand of power to keep ‘quick release’ rate under control. Due to the end of life of Capacitors of both the series after a long period of its use, it is required to change the old with a new set of both series and once the Capacitors is replaced, system becomes empowered again.

In the Figure-I, on the main chassis (5) made of insulating coating or materials, Source motor (1), necessarily a high speed DC motor, which has been shown tightly attached by an insulating bindings on both ports (7 and 11) and in the arrangement of specially sized mechanical worm gear box (10) of variable type to meet the required & rendering rotation per minute (RPM) rate of Power generator (2) and Source motor (1), is done i.e. herein 10/1 ratio where, rendering rotation per minute from Source motor (1) is divided by the required RPM of Power generator (2) therefore, the radius of Source motor wheel is ten times smaller than the radius of Power generator's wheel (9) so, when Source motor wheel (8) completes ten rounds, the wheel of Power generator (9) completes its first required round by the use of a Worm Gear Box (10) where, such a fixation of rotation per minute ratio depends upon the make of these two prime part of Automatic Power Connector System Machine (3) with a mechanical advantage set-up as shown on it. According to the principle of moments Mechanical advantage gained by such an arrangement could be defined as:
W*l¹=P*l² or W/P=l²/l¹

Where, a straight lever as shown in Figure-IV-A with parallel forces acting in the same plane is considered. Point A and B through which the load and effort is applied are known as load and effort, respectively. F is the fulcrum about which the lever is capable of turning. The perpendicular distance between the load point and fulcrum (l¹) is known as load arm and the perpendicular distance between the effort point and fulcrum (l²) is called effort arm.

The basic requirement of this system is to provide a continuous mechanical thrust to the Power Generator (2) and to the Combined Power Connectors (3) device by the Source Motor (1). For achieving this important target an advantage of mechanical output through the appropriate Gear Box (10) arrangement is done in such a style which fulfills the need of circuit (the circuit of Source Motor and the Power Generator) in the terms of their mechanical thrust need and capacity, smoothly. Mechanical advantage is gained through the angular kinetic velocity of moving bigger wheel at the smaller wheel, for the power generator (2) with a formula:
½Iw²
Where I is the momentum of Inertia of the mass about the centre of rotation and w (omega) is the angular velocity in radian units which is applied on the wheels in opposite of the levers' theory as shown in Figure-IV-B. Power Generator (2) gains the mechanical advantage to generate power in the equal equation of the output that this formula depicts to.

The main chassis (5) made of insulating materials/coatings can have round shape also where the different size of wheels can be arranged to run properly through Pulley arrangements as shown in Figure-III/C or through a Ratio-wheel arrangement as shown in Figure-III/D as per the requirement of this System Machine. Arrangement of Worm Gear Box Figure-III/A (Internal mechanism in Figure-III/B) is obviously a good arrangement compared to any other arrangement similar to this type and target.

Speed of Power Connector device (3) can be put on variation as per the requirement of the series and if the system turns slow due to fall of electrolyte of the Capacitors and to meet such requirement a system machine to control the speed of Power Connector device (3) can be placed separately otherwise its operation is left on the self-control system. Self-control system is such a condition of self operation where system requires no extra/out source arrangements to control or operate it.

This Automatic Power Connector (3) System Machine require a starter motor (4) to put the system on first initial thrust and thus to bring the activation section on work where a pair of rechargeable batteries (39) and (40) brings the whole system to complete activating stage and substitutes the rechargeable batteries with Capacitors, after gauging well to any or both returning series from repositories.

So, In prior to start the Automatic Power Connector System Machine to work with an/any viable condition, the arrangement of activating to the circuit of Capacitors in the both series, is done first and for this the Start-up Switch (41), along with charging switches (35) and (37) are turned connected to the both set of Connectors. If the phases of the discharging Connectors (46) are touching any of its pole, discharged power from the rechargeable batteries (39 or 40), comes at the port (50), which is a port of Secondary output section to run the Source motor (1). Now, by turning the Final Starter Switch (59) ON, Source Motor (1) starts running. But this would not be a final start. Rechargeable batteries (39 & 40) are no longer in capacity to supply the power to run the source motor (1). Its internal/circuit resistance starts performing a ‘depressive outcome’ of slowly released power from its charged plates, causing the system to stop. The best solution for the system to gain a smooth start, is to get simply a first thrust from the use of Starter Motor (4) and bring the rechargeable batteries of double series in use temporarily and after getting the required speed and the series of capacitors activated, change the phase connectivity to its own. So that to prove that the system is running on its own. While working in normal automation mode or via external source mode, ‘temporary accumulating’ Connector (30) starts activating both the series of Capacitors (36 and 38) by accumulating the produced power in both of them in one-by-one order on a very high speed, generated by the source motor (1) and which is, due to the multi-phases arrangement, touches to at an Intangible pulse rate. Once the meter reads circuits, ‘ACTIVATED’ or in any appropriate terms of percentage of its capacity to get the burden on its own, temporary external source is truncated immediately and the system is shifted to run on its own capacity. The simple procedure for starting the system is as follows:

[If necessary, lever (12) is set at first on selected Power Generator. Thereafter:]

| | |
|---|---|
| (1) Set Main Runner Switch (42) | OFF |
| (2) Hold the First thrust switch (57)for a moment | PRESSED ON |
| (3) Turn the Start up (41) Switch | ON |
| (4) leave the First thrust switch (57) to let it come back | — |
| (5) Check the Speed (13) and Power Production (15) | OK |
| (6) Turn the Main Runner Switch (42) | ON |
| (7) Start up switch (41) Turns automatically | OFF |

Once the first Production Meter (15) along with System wheel Speedometer (13) read the condition OK for self operation, Main Runner Switch (42) is turned ON and it turns Start up switch (41) OFF automatically at the same time. In prior of starting the system to run, this is necessary to fix the rotating wheels well aligned.

Such a system to fix the parameters of actual activation depends upon the readings by several meters and after the power production is well started. By comparing the speed at speedometer (13), AC Volt meter (17), while it crosses to AC Transformer (16) and DC Watt meter (19) while the power crosses to the Rectifier (18), it is well determined whether the series of Capacitors have gained the capacity to make a ‘quick release’ for running the system's source motor (1) or not.

The power is passed hereafter into a charge selector multi-switch (20) to select normal charge (21), reduced (22) or a boosted (24) flow of current to keep the system activated, is selected. The item 22 and 24 are typically a selector device of their different nature. Item 22 is a variable resistor device and its outcome is being read at ohm-meter (23). Similarly, Item 24 is a variable Booster device, in fact this is a variable DC Transformer, which works to vary upward and downward automatically by the reading outcome of power supply to the source motor and its activities is gauged by a relay monitor (25) in the terms of Volts. Sometime, this device is kept in a fixed condition also to accommodate source motor's requirement. Next device (26) the input/output relay junction is a very important device as it extracts the produced power before or after sending it to the live circuit adequately, while the rest, it keeps or sends to the port of first output section (53). This device (26) works like a semi-circuit breaker device where the port of Connection to the ‘quick release’ section (47), the section of circuit that links this device to the ‘quick release’ Connector (46) directly, is opened to a variable unit and that is also a self controlled device while the other is put on, for a normal release. All this monitored by the meter/s (27) installed on the control panel. The power directly flows into the first connector (30) through its receiving port (29) which is a ‘temporary accumulation’ connector in fact. Phases of this connector by the speed of the source motor (1) changes rapidly and generates a unique ‘Intangible pulse’ in its active phase utilization. Now it starts the use of second part of Power Connectors.

Multi-Phases Connectors (3) can be shaped of several type as if it can produce the similar result. A multi-Phase Connector (3) can play a crucial role not only in the current system but also with several conventional industrial and automobile mechanisms. With the purpose of convenience, system presents two basic types of Connectors, the working nature, purpose and the performance of both are same. These are: (a) Shaft Connector and (b) Roll Connector. Both are tended to generate a ‘Intangible pulse’ of utilizing the active phases and an equilibrium in the series of ‘temporary accumulation’ and ‘quick release’ of the active current supply and overall, without a single percent chance of circuit collision.

All/Any Power connector, that this system uses, is a device to transmit the power to next port in an absolute opposition of another part that runs in an equal pace but with a necessary opposite nature of work. So that when first part of it finalizes the Work-X¹ second part finalizes the Work-Y². In the next turn of action and at the rate of less than a half round of its total circumference of active Phases, touching Shaft or the Roll turns in a very rapid motion on/through it with the speed of its prime mover, and the finished actions are shifted to a new version. Now, First part of the same connector finalizes the Work-X² and second part finalizes the Work-Y¹. Where X denotes the work of accumulation of produced power and Y denotes the ‘quick release’ of accumulated power. Digits, powered to them are the part of their works they are fixed to.

Connectors generate ‘an intangible pulse’ of power utilizing period which is the prime necessity of the system therefore, it uses the circuits of accumulation and ‘quick release’ in double. It is, therefore, the term X¹ and X² has been used to denote the accumulation of Power in or going through double series. Similarly, the term Y¹ and Y² denotes the ‘quick release’ of accumulated Power coming out from or coming through the double series. Connectors require here, to be dealt more lucidly as the distribution of Phases from it is the matter of an extended explanation.

In the Figure-I, Function and flow of current from and to the Connectors involves all three sections shown on the same sheet. Device Number-3 in Figure-I is a Connector device in combined form where the Produced power is brought through the single live wire at its first receiving port (29) and is distributed among two typical phases as narrated above, number of which can further vary from two to a uncertain limit depending upon the size and the internal design of the connectors. Though, for gaining such a bigger digits of active phases, arrangement of more than one set of connector can be done with an extended surpass of coiling on each of that, but this extension will require an extra precision to maintain with the supplying units in the same circuit. As narrated above, the brought-up power is distributed rapidly among the phases to pass it in the circuits through passing line 31-a and 31-b in one-by-one order, shown in the same figure-I. As narrated above, when the first series is activated (assume it in a time=Ta²) through the first phase (31-a) of accumulating Connector (30), discharging connector (46) activates the second series (45-b) by releasing the accumulated power (assume it in a time=Ta² again because of different port and device) quickly from the second series of capacitors (38) at the same time (T). The event is repeated at the next ‘time’ (T), and necessarily opposite to the first event happened in first time (Ta²), by the accumulating Connector (30) and ‘quick release’ connector (46) (in time=Ta²). Now the accumulating connector (30) activates ‘again’ to the second series (assume it in a time=Ta¹) which the discharging connector (46) had just made it, to the first series of Capacitors (36), emptied through, out going Phase (47) for the Source Motor (1) and now, in this next turn of action, discharging connector (46) is releasing the power from first series of capacitors (36) (assume it the time=Ta¹) to run the same Source Motor (1). It happens repeatedly for the period Capacitors are ready to work till.

Design of Connectors can be shaped in the form of a Shaft (Figure-II/A-3) or of Roll type (Figure-II/B-2 the basic function of which is described in Figure-II/B-1). In a Shaft type of Connector there are two phase touching shafts (85) and (95) made of conducting materials and having the mechanical function like a shock-observer. The rapidly running ports of ‘temporary accumulation’ and ‘quick release’ are made on the top of each shafts on both side, recognized as charging transmission line (93) and discharging transmission line (94), active bearing roll of ‘temporary accumulation’ (87) and ‘quick release’ (92) both passed on to the phase receiver ports 105-103 and 104-102. When Phase touching shafts (85 and 94) moves with the speed of Source motor (1) in full pace it starts touching to both the phases in one-by-one order and thus supplying and receiving the power from and into, for the specific use, they have been fixed to. In the first part of connector (30), which is tended to ‘temporary accumulation’ power comes in from receiving port (100) to pass at active bearing roll for ‘temporary accumulation’ (87) through phase touching shaft (85) and is distributed in one-by-one order to both the series of Capacitors (36 and 38) through distributed phases 103 and 105. Same activity takes place in the second part of connector (46) which is tended for a ‘quick release’ to run the Source motor (1). Power comes here after ‘temporary accumulation’ at receiving port (101) and reaches to active bearing roll (92) for making the ‘quick release’ a success by passing it through the distributed Phases 102 and 104. Number of such phases can be increased to gain much higher pulse rate (as shown in the Figure-II/A-1) of power transmission depending upon the need of capacitors and the system's internal circuit or if, required by the output relay section. Multiplication of pulse rate by any type of connector, could be managed adequately with the internal circuit's and the circuit that goes to output section, apparently. It is, therefore, the system has used a double phase connector as shown in Figure-II/A-2 to do the work in a noncomplex format. No big changes or the increase-decrease of Instruments takes place with the Connectors (3) even if the power format is turned double.

A roll type Connector is more convenient than the Shaft type of Connector to operate with. The moving object in this connector is its central roll (132) which touches both of the active phases in one-by-one order as Shaft type module. But the Active Phases (133)(122)(131) and (145) in this Roll type of Connector are active bearing rolls, constantly installed in an exact dimension of 180 degrees to their face and in the opposite of phases installed in another part of the same Connector. It is, therefore, when first part of connector (30) begins its work of ‘temporary accumulation’ toward first series of capacitors (36), second connector (46) begins working to make a ‘quick release’ for the Source Motor (1) from the second series of capacitors (38). This activity is repeatedly altered at the rate of pulse generated per second (T) in Connector (3) as the phases after the Central roll (132) jumped over it, changes the direction of power flow as represented in the Figure-II/B-2. In the second step of ‘temporary accumulation’ (Ta) power is sent out to the second series of Capacitors (38) and at the same time second part of the same connector (46) as the second step, starts ‘quick release’ of powers to keep the Source Motor (1) continuously running. ‘Quick release’ by the second part of the same connector (46), set in opposite of first Connector (3) by position, nature, phase and result, works a very crucial role. Just opposite of the Phase breaking steps of the first part, this important second part of the same connector, receives the broken phases to unite them intangibly while making the supply of power uninterrupted to the source high speed motor, despite the broken phases, alike the first connector, are never set united or even touching to each other rather it happens only in the high speed condition of movement which is quite intangible or invisible as a normal observation and it is therefore, in the system, it has been named an ‘intangible pulse’ of using the active phases in altered order of one-by-one.

Returning accumulated power, after it was received at the external ports (45-a & 45-b) from both the series of Capacitors (36 and 38) after being checked at ‘equalizing gauge’ (43 & 44), enters into the second part of the connector (46) where both the discrete ports (45-a & 45-b) get intangibly united in multiple section alike it had broken into parts in the first part of the Connector (30) for accumulation in two series and with a multiples of phases therein. Now, after the discrete phases are set united artificially, as their internal change of shifts on working shafts could not be seen easily, power comes over the port of final release (47), a ‘quick release’ port of source runner in fact. The Power is received out at the secondary output section (50) where again, as per the compared parameters of other meters kept here, with an Ammeter (51), extra energy is moved out for any external uses through an extra port (52) as if the system is gaining the power from its device (48) installed in pair or in plurality between each phases of the connector/s (3), as the external phase that equally, in a repeated equation, shares the internal surface length with rest of the phases. In such a condition, connector/s (3) may comprise of basically four types of phases i.e. (i) active phases for accumulation in part-A, (ii) active phases for quick release in part-B arranged in an opposed alignment of part-A, (iii) active phases between each phases of both part-A&B, for retrieving the bonus release of power and (iv) neutral phases between each of the three type of phases in both part of the connector/s, equally. There is ongoing effort to make system machine that is smaller, lighter, cheaper, and have a greater capacity. It is hoped that Automatic Power Connector System Machine can replace conventional electric tecnologies in various applications as well.

The evaluation is reviewed again on the next Port, the Primary Output Section (53) where some complex comparison is done with the power before accumulation and after accumulation. This gauging finalizes the final turn of starting the system to run at its own. Temporary connectivity of rechargeable batteries (39 and 40) for activating the circuits of the Capacitors are finally done here with a parameter to fix an idle condition to truncate the temporary connectivity of batteries or of any external source. On signaling positive, system starter switch (56) starts gaining power right from its own source by instantly truncating the external or the rechargeable batteries connectivity and thus the system starts running at its own power and source.

Use of Connector (3) in the system is an urgent need which bars all/any series collision while (i) generating (ii) condensing and (iii) quickly releasing all at almost the same time ensuring the Positives that the:
(1) Source Motor (1) is receiving power from both series of Capacitors (36&38) in one-by-one order (‘quick release’)
(2) Power is accumulated in both series of Capacitors (36) & (38) in one-by-one order (‘temporary accumulation’)
(3) ‘temporary accumulation’ and ‘quick release’ of power is taking place in an alter order, rapidly
(4) ‘temporary accumulation’ and ‘quick release’ of power is taking place at the same time on different port.
(5) There is no Collision of series, passing flow of current in it and
(6) There is no spark or the gap shifts of running phases is/are seen and the system is thus, running smooth and safe.

All these things happens with a set of possible negations:
(7) Motor's potential capacity decreases by the rate of mounting internal heat and therefore the circuit resistance.
(8) Power Generator is not sending an efficient amount of energy due to mounting heat and internal circuit resistance.
(9) Other mechanical system i.e. Gear Box and the Power Connector are generating mechanical resistance to cause the system to loose potential power of works
(10) There are other circuit resistance found
(11) Capacitor's capacity of accumulating power and releasing them quickly is loosing
(12) Prime Gauge of the system is indicating that the system is falling down continuously.

Most of the negations mentioned above from para-7 to 12 are well evaded with the installation of a few other devices not mentioned here in details with this Patent Specification.

Having to choose between brush-type or brushless motors can complicate the selection of a Source DC Motor (1) for the system. Several motor parameters are the same for both brush-type and brushless DC Source Motors (1). One of these is motor constant, Kₘ. It is used during motor sizing because it is a figure of merit of the motor power-to-torque ratio. Kₘ is proportional to the ratio of peak torque, Tₚ, to peak power, Pₚ, at stall:
Kₘ=Tₚ/√Pₚ.

Kₘ is also proportional to the ratio of torque sensitivity, Kₜ, to motor terminal resistance,
Rₙ:Kₘ=Kₜ/√Rₘ.

After the required Kₘ has been determined, motor must also satisfy physical size and inertia requirements of this new system. Winding resistance is a major factor in motor selection because it seriously affects Kₘ. Winding resistance and motor current produce power loss in the form of heat and motor temperature rise (TPR). These losses are also referred to as l²R losses and directly degrade motor efficiency. Keeping the motor's temperature low and loss of energy with that is undoubtedly a major issue but it involves several other factors also. For a best result, system prefers to use the modern and latest models of the DC Source Motor (1) to run the whole system smoothly. Most brushless DC Motors are constructed with an outer-wound stationary armature also and a rotor consisting of permanent magnets. Heat transfers more efficiently from the wound armature to ambient air in this configuration because heat dissipates from the armature core to the outer metallic housing, not conducted through the shaft like most brush-type configurations do have. So, considering these problems in default are not the matter of this Patent Specification rather, this is taken in a careful selection of DC Source Motor (1) and the catalog direction to use them efficiently. Brushless DC Motors are better suited for applications needing a wide speed range. Speeds from a stalled condition to more than 60,000 rpm or more are not unusual.

Most motor windings are copper wire which has a positive temperature coefficient. A winding temperature rise from 25 to 155° C. increases wire resistance as much as 50%. Likewise, a proportional decrease in resistance occurs for temperature drops. Since brushless DC Motors have no commutators or brushes, brush and commutator arcing does not limit speed.

Though the brushed series DC motor is the most affordable and readily available motor. Brushless DC motors require expensive controllers. Permanent magnet motors are very efficient, but only in a very narrow rpm band, and quickly lose their efficiency in the varying speeds of normal driving. For these reasons, the brushed series DC motor is the motor of choice for DC systems but, due to urgency of having a constant high speed as the source driver, evaluated in the terms of x-time greater than the y-time movement per minute rate of power generator (2) to gain a necessary mechanical advantage at its armature. So, instead of referring to a ‘10 hp motor’ or a ‘15 hp motor’, capacity fixation of system source Motor (1) it is left to evaluate the same in the context of available models, range, need and capacity of such Motor. It is, because, horsepower will vary with volts and amperes, and peak horsepower will be much higher than the continuous rating. This can be achieved by using disparate/different classification of motors which AC/DC, brush/brushless motors of even in a lesser RPM that suits well to the system.

Capacity and work efficiency of a DC Source Motor (1) is always a matter of consideration with the needful view of its specific configuration that matches with the need of the system. A generator (2) in the system must be as efficient as it must activate at least a single series of accumulation continuously for a certain period termed as ‘x’. In the other word, accumulation must be as efficient as it must run the source motor (1) efficiently (p) for a period termed as ‘x’. The efficiency of the motor is well defined in the physical terms but here system counts it in the terms of mechanical advantage (ma) as it have some borne capacity to adjust the tampered calculation. So, starting right from the generating device (2), with its Rotation requirement (RPM), to adjust that with the Full speed capacity of the Motor (1) which has been brought in with a high speed configuration. This is in comparison of the Generator's net rotational demand to produce an adequate amount of energy to activate at least any one of the circuit, that, this system require. Thus the need of the system as regard to High speed Source Motor (1) and the Power Generator (2) is well configured and according to that, arrangement of gear box (10) to reduce the out coming speed of the source motor (1) to generate the mechanical advantage (ma) for making an adequate thrust upon the armature of the AC Power generator (2) is done with full care. So, considering this way of formulating the system's need it is clear that the source Motor (1) of the system must be as efficient as it must run the Power generator (2) adequately with a required mechanical thrust with the help of gear box arrangement installed between them. Once the catalog of these two major devices is configured, capacity of other devices becomes an easy task to fix with, including the capacitors (36-38) or rechargeable batteries (39-40) with their enumerated presence in the pair of series. After fixing the required number of capacitors/rechargeable batteries in any one series, to make them double later, capacity of the devices is fixed hereafter. Though the activation or the ‘quick release’ is done in one-by-one order, therefore, capacity of the devices is measured as per the calculation measured at any one of the receiving port of (i) accumulation (35 or 37) and at the port of (ii) final consumption, measured in a meter (60) before arriving to the high speed source Motor (1).

Capacitors (36-38) used in both series of the system are a common device that have thin conducting plates (usually made of metal), separated by a layer of dielectric, then stacked or rolled to form a compact device. Instead of using a Glass type Capacitor which is extremely stable and a reliable type, this new system uses a Paper Direct Current Variable Capacitor that uses eletrolyte inside its cabin to cover the double layers of conducting active plates. Paper dielectric and aluminum foil layers rolled into a cylinder and sealed with wax plays a crucial role in operating the system with or without the use of Kinetic Bonus Receiver Device (48), centrally placed between the active phases of the Connector. A capacitor can be as low values up to a few μF, working voltage up to several hundred volts, oil-impregnated bathtub types to 5,000 V used for high-voltage power supplies.

Function and Utility of a condensing device (36-38 & 39-40) is very crucial in the system. It works to hold the power for a very short period until a demand of touching shaft of the Connector (46) arrives for running the high speed source motor (1). As the system requires no external help in any form while at infinite run and therefore require its capacitance to work in a good order and condition. A high quality paper dielectric capacitor for this purpose have been used, permittivity level of which is though not greater to all other, but the nature and the capacity have been traced in it, matching with an added feature that if necessary, there would be no need to arrange a complete series of Capacitors rather a single piece of it on each series would do the work efficiently. The capacitance of this capacitor can be increased by increasing the permittivity of the dielectric material inside it, if necessary.

In case system do not have such a powerful capacitors to put them in the series instead of a group of capacitors to compete the equal capacitance as required by the system so to have a cumulative thrust rather a series resistance always working in opposite direction or sometime in a static condition of it which, is found quite generally in the working series. It is therefore, suggested that to evade such a conventional hurdle which can stop the run of the system, prefer to ‘unite all the Capacitors arranged as per the series requirement, at a single juncture and never take the output in discrete order’. It thus, helps the system to run smooth and free from any conflicts that may appear in the running series. Figure-V, as clearly evident in figure-I also, as device-36&38, representing such arrangement, may be more helpful to understand the function and can be assessed well how it renders a cumulative thrust for a required level of output of the High Speed Direct Current Motor (1) as the premier Source Motor.

Chances of extracting extra energy or the energy gained in extra must be measured in the terms of net output. Though the system can use the multiple series of accumulation and uses mostly the two in ‘one-by-one’ order for running the source motor (1) so, the rest of the series can be used as exactly, the output source. It becomes possible due to the intangible pulse rate of power transmission always set at almost the same time and using the power half of that in the term of ratio and less than that in the term of a certain period, it is obvious to extract the power from the running series for which an extra arrangement at the primary output port (53) and secondary output port (52) has been duly arranged. With a gain of power, system thus proves its utility and the novelty.

We claim:

1. An Automatic Power Connector (3) machine comprising of
power source unit in single, pair or in plurality
brought in use by the arrangement of
altered active phases of the Automatic Power Connector (3) machine
to generate an intangible gap of period while transmitting the generated power,
at the gain of mechanical advantage
by the power generator
and by the source motor; driving the Automatic Power Connector (3) machine.

2. An automatic Power Connector (3) system machine in accordance with the claim-1, wherein:
Temporary Accumulation into and Quick Release of power from
Automatic Power Connector (3) systems' repository/s,
at the rate of Intangible Pulse,
serves to drive the source motor (1);
Source Motor serves to drive the generator (2), and the Power Connector (3)
at the gain of mechanical advantage;
and eliminates the use of external energy.

3. An automatic Power Connector (3) system machine as according to claim-1, wherein: an Automatic Power Connector (3) comprising:
a number of active phases of
Repositories and neutral state
between each of the active phases
that serves to operate
(i) the Source Motor (1)
(ii) accumulates the power and
(iii) by transmitting power in
an altered order
at an intangible pulse rate.

4. An automatic Power Connector (3) machine according to claim 1, wherein:
Automatic Power Connector (3) generates
an intangible pulse of
power transmission in an altered order
benefiting the running circuit/s
by enhancing the number of Active Phases
for output section
through multiplied circuit efficiency.

5. An Automatic Power Connector (3) System Machine according to claim-1, wherein:
an electric power Connector (3) comprising:
a number of active phases of Repositories (i.e. 36, 38) that serves
to generate a Collision-free Temporary Accumulation into and
Quick Release of power
from Repositories on it's active port/s
at the rate of an intangible pulse.

6. An automatic Power Connector (3) system machine according to claim-1, wherein:
an electric power Connector (3) comprising:
A number of active phases with neutral phase
to operate the series of power Repositories
in the terms of temporary accumulation into and
quick release of power from it
to run the source motor (1)
at its own source
and for the generation of Power by the generator (2);
and the electric Power Connector (3) that serves also to release quickly
the accumulated power there to and from, after accumulation
at the rate of an intangible pulse.

7. An automatic Power Connector (3) system machine, wherein:
an electric power Connector (3)
enables the system to generate a state-of-equilibrium
in the running circuit of accumulation and quick release.
by transmitting the power in a specific order and condition.
